(19) United States
(12) Patent Application Publication
(10) Pub. No.: US 2024/0257053 A1
(43) Pub. Date: Aug. 1, 2024

(54) SYSTEMS AND METHODS FOR RULE-BASED APPROVAL OF REQUEST

(71) Applicant: Rakuten Symphony India Private Limited, Indore, MP (IN)

(72) Inventors: Ravish KUMAR, Indore (IN); Zafar MANSURI, Indore (IN)

(73) Assignee: Rakuten Symphony India Private Limited, Indore, MP (IN)

(21) Appl. No.: 18/018,451

(22) PCT Filed: Dec. 27, 2022
(86) PCT No.: PCT/US2022/054074

§ 371 Date: Jan. 27, 2023

(51) Int. Cl. G06Q 10/10

(52) U.S. Cl. CPC G06Q 10/10

(57) ABSTRACT

A method of automatically approving change requests within an organization. The method can include creating a change request (CR) based on a received request to create the CR, and defining one or more conditions associated with the CR, wherein the conditions are based on at least one of a domain level, security level, or operations level within the organization. In addition, the method may include determining if the CR meets the one or more conditions with respect to the domain level within the organization, and upon determining that the CR meets the one or more conditions with respect to the domain level within the organization, automatically approving the CR at the domain level of the organization.

### BACKGROUND

### Technical Field

The present disclosure described herein relates to a rule-based order change request approval method and system.

### Background

Changes can frequently occur in the processes and equipment of organizations, businesses, enterprises, and network service providers. Many of these changes need prior approval to prevent adverse effects on the organization or the services provided by the organization. In particular, unintended results can readily occur if modifications to a system, process, or equipment are not approved by a knowledgeable authority or not properly communicated to all affected parties within the organization. Currently, when a change request (“CR”) is submitted within an organization, it must be manually approved at various stages, such as at the domain level, security level, and operations level. This manual approval process can be time-consuming and highly inefficient within the organization.

Hence, what is needed is an automated rule-based process for implementing CR's within an organization that is fast, flexible, efficient, cost-effective, and utilizes minimal computing resources.

### SUMMARY

According to example embodiments, the disclosure described herein provides rule-based process that can take one or more references from a predefined database to make modifications to a CR status thereby resulting in an efficient and simplified change request approval process within an organization which can provide fast results and require no manual human intervention as compared to conventional processes and systems. In some embodiments, the system and method of the disclosure described herein, allows CR approvers to configure and select various combinations of existing CR creation form field options which can be matched or compared against every new CR submitted thereafter. In addition, rules or conditions can be created separately at a domain level, security level and operations level (e.g., Operation Center or Service Excellency Center (SXC) level). Further, creating no rule at any level can mean that all CR's will continue to be manually approved. In other embodiments, CR approvers can select multiple options for each field to allow CR's to auto approve for multiple combinations with a single rule. In addition, a newly submitted CR can be matched or compared against such a rule for all fields pre-configured within the rule. Further, in scenarios where if a CR has the same subset of values for all fields in the rule, then the CR can be allowed to auto approve at that level.

According to other exemplary embodiments, a method of automatically approving change requests within an organization is disclosed. The method can include creating a change request (CR) based on a received request to create the CR; and defining one or more conditions associated with the CR, wherein the conditions are based on at least one of a domain level, security level, or operations level within the organization.

In addition, the method may include determining if the CR meets the one or more conditions with respect to the domain level within the organization; and upon determining that the CR meets the one or more conditions with respect to the domain level within the organization, automatically approving the CR at the domain level of the organization.

Further, the method may include determining if the CR meets the one or more conditions with respect to the security level within the organization; and upon determining that the CR meets the one or more conditions with respect to the security level within the organization, automatically approving the CR at the security level of the organization.

Also, the method may include determining if the CR meets the one or more conditions with respect to the operations level within the organization; and upon determining that the CR meets the one or more conditions with respect to the operations level within the organization, automatically approving the CR at the operations level of the organization.

Further, the method may include sending the approved CR at the domain level, security level, and operations level to an approval board.

In addition, the method may include upon approval of the CR from the approval board, automatically executing the CR within the organization.

Moreover, the method may include determining if the CR is a remote method of procedure.

Also, the method may include upon determining that the CR is not a remote method of procedure, determining if the CR is high priority.

Further, the method may include upon determining that the CR is high priority, determining if the CR meets the one or more conditions with respect to the operations level within the organization; and upon determining that the CR meets the one or more conditions with respect to the operations level within the organization, automatically approving the CR at the operations level of the organization.

In addition, the method may include sending the approved CR at the operations level to an approval board; and upon approval of the CR from the approval board, automatically executing the CR within the organization.

In other exemplary embodiments, an apparatus for automatically approving change requests within an organization, including a memory storage storing computer-executable instructions; and a processor communicatively coupled to the memory storage, wherein the processor is configured to execute the computer-executable instructions and cause the apparatus to create a change request (CR) based on a received request to create the CR; and define one or more conditions associated with the CR, wherein the conditions are based on at least one of a domain level, security level, or operations level within the organization.

In addition, the computer-executable instructions, when executed by the processor, may further cause the apparatus to determine if the CR meets the one or more conditions with respect to the domain level within the organization; and upon determining that the CR meets the one or more conditions with respect to the domain level within the organization, automatically approve the CR at the domain level of the organization.

Also, the computer-executable instructions, when executed by the processor, may further cause the apparatus to determine if the CR meets the one or more conditions with respect to the security level within the organization; and upon determining that the CR meets the one or more conditions with respect to the security level within the organization, automatically approve the CR at the security level of the organization.

Further, the computer-executable instructions, when executed by the processor, may further cause the apparatus to determine if the CR meets the one or more conditions with respect to the operations level within the organization; and upon determining that the CR meets the one or more conditions with respect to the operations level within the organization, automatically approve the CR at the operations level of the organization.

Moreover, the computer-executable instructions, when executed by the processor, may further cause the apparatus to send the approved CR at the domain level, security level, and operations level to an approval board.

In addition, the computer-executable instructions, when executed by the processor, may further cause the apparatus to upon approval of the CR from the approval board, automatically execute the CR within the organization.

Further, the computer-executable instructions, when executed by the processor, may further cause the apparatus to determine if the CR is a remote method of procedure.

Also, the computer-executable instructions, when executed by the processor, may further cause the apparatus to upon determining that the CR is not a remote method of procedure, determine if the CR is high priority.

Moreover, the computer-executable instructions, when executed by the processor, may further cause the apparatus to upon determining that the CR is high priority, determine if the CR meets the one or more conditions with respect to the operations level within the organization; and upon determining that the CR meets the one or more conditions with respect to the operations level within the organization, automatically approve the CR at the operations level of the organization.

In other exemplary embodiments, a non-transitory computer-readable medium comprising computer-executable instructions for automatically approving change requests within an organization by an apparatus, wherein the computer-executable instructions, when executed by at least one processor of the apparatus, cause the apparatus to create a change request (CR) based on a received request to create the CR; and define one or more conditions associated with the CR, wherein the conditions are based on at least one of a domain level, security level, or operations level within the organization.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture for the rule-based CR approval system and method of the disclosure described herein according to one or more embodiments;

FIG. 2 illustrates various modules and a process flow for the rule-based CR approval system and method of the disclosure described herein according to one or more embodiments; and

FIG. 3 illustrates another diagram of a process flow for the rule-based CR approval system and method of the disclosure described herein according to one or more embodiments.

FIG. 4 illustrates a graphical user interface for creating a CR and one or more rules associated with the CR within a CR form template for the rule-based CR approval system and method of the disclosure described herein according to one or more embodiments.

### DETAILED DESCRIPTION

The following detailed description of example embodiments refers to the accompanying drawings. The same reference numbers in different drawings may identify the same or similar elements.

The foregoing disclosure provides illustrations and descriptions, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “nonlimiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive nontransitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

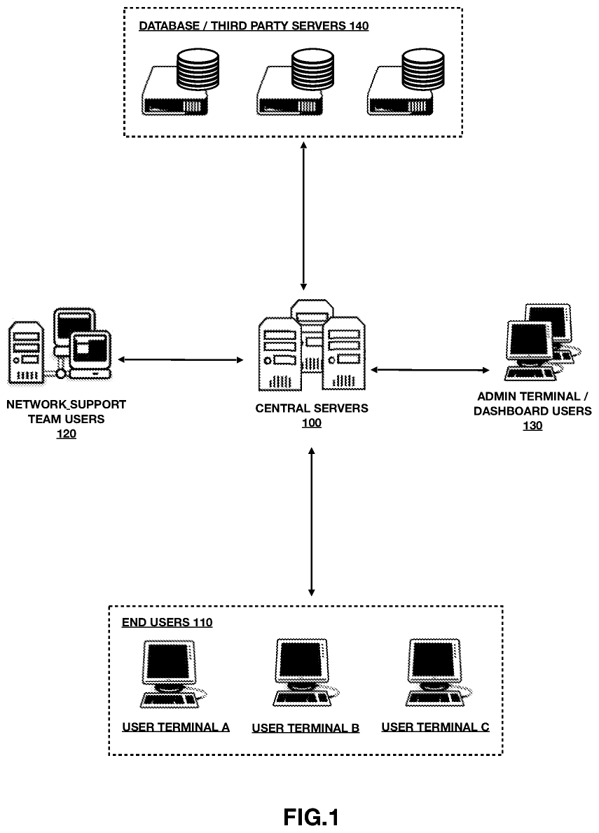

FIG. 1 illustrates a diagram of a general network architecture according to one or more embodiments. Referring to FIG. 1, end users 110, network support team users 120, and admin terminal/dashboard users 130 (collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the disclosure described herein according to one or more embodiments. Here, users 110 can be any type of customer, network service provider agent, or vendor, among others, of a network or telecommunication service provider, such as users operating computing devices and user terminals A, B, and C. Each of users 110 can communicate with servers 100 via their respective terminals or portals, wherein servers 110 can provide or automatically operate the network impact prediction engine system and method of the disclosure described herein. Users 120 can include application development members or support agents of the network service provider for developing, integrating, and monitoring the rule-based CR approval system and method of the disclosure described herein, including assisting, scheduling/modifying network events, and providing support services to end users 110. Admin terminal/dashboard users 130 may be any type of user with access privileges for accessing a dashboard or management portal of the disclosure described herein, wherein the dashboard portal can provide various user tools, GUI information, maps, open/closed/pending support tickets, graphs, and customer support options. It is contemplated within the scope of the present disclosure described herein that any of users 110 and 120 may also access the admin terminal/dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data, such as current, real-time, and past network related historical and KPI data, may be stored thereon and retrieved therefrom for network analysis, RCA, artificial intelligence (AI) processing, neural network models, machine learning, predictions, and simulations by servers 100. In addition, servers 100 may include the digital twin module of the disclosure described herein. However, it is contemplated within the scope of the present disclosure described herein that the rule-based CR approval system and method of the disclosure described herein can include any type of general network architecture.

Still referring to FIG. 1, one or more of servers or terminals of elements 100-140 may include a personal computer (PC), a printed circuit board comprising a computing device, a minicomputer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a fieldprogrammable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, sixth generation (6G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like. It is understood that other embodiments are not limited thereto, and may be implemented in a variety of different architectures (e.g., bare metal architecture, any cloud-based architecture or deployment architecture such as Kubernetes, Docker, OpenStack, etc.).

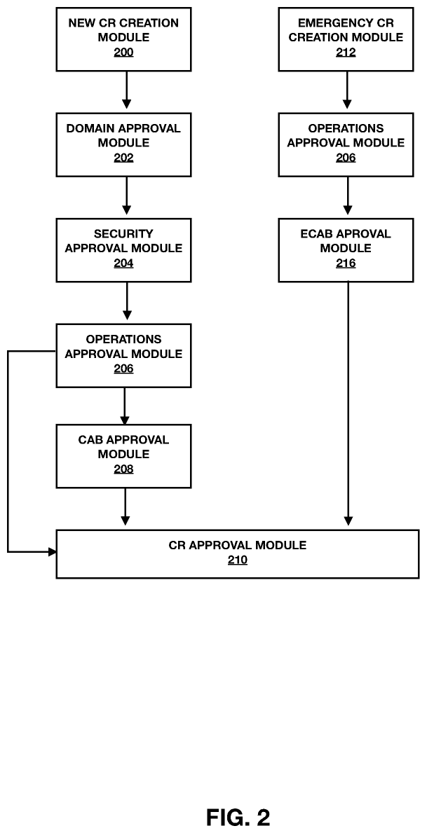

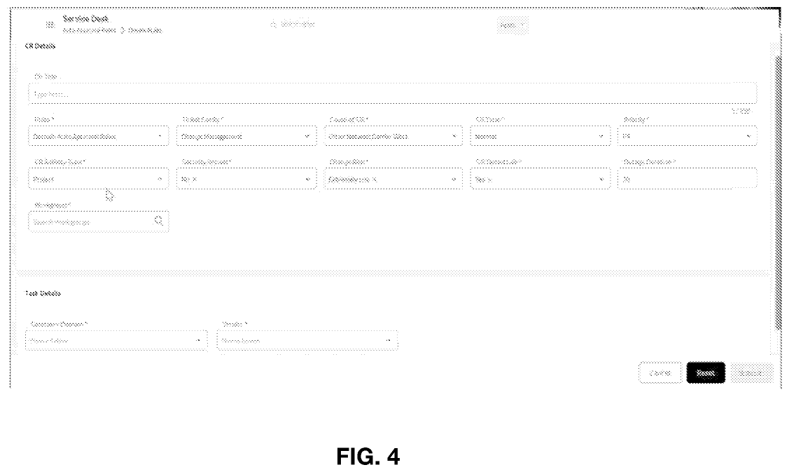

FIG. 2 illustrates various modules and a process flow for the rule-based CR approval system and method of the disclosure described herein according to one or more exemplary embodiments. In particular, a new CR creation module 200 can allow for the creation of a custom CR within the system and method of the disclosure described herein within an organization and further assign/define various rules or conditions for the created CR. After the CR is created at module 200, the process can proceed to a domain approval module 202 for approval of the CR at the domain level of the organization. FIG. 4 illustrates one exemplary embodiment for creating CR details and defining rules, which will be later discussed within the disclosure. In particular, module 202 can include a domain rule template that further includes task level parameters to allow for specific rules-based parameters to be defined based on the domain, vendor, or network element (NE) type, among other conditions. In some embodiments, all the fields within a CR form, such as shown in FIG. 4, can provide for multiple selections by a user. Here, in operation, the domain approval module 202 can check an auto-approval rule set for a CR (wherein the auto-approval rule set pertains to domain level criteria), and if certain conditions and criteria are met with respect to the auto-approval rules, then the CR can be automatically approved by the domain approval module 202 (conversely, if conditions of auto-approval are not met, then manual approval may be required). According to an embodiment, every stage (or level) has its own auto-approval template and conditions.

Still referring to FIG. 2, after the domain approval module 204, the CR can be sent to a security approval module 206 for approval of the CR at the security level of the organization. Here, a security level template form within the system can be used for the approval process, wherein the template generally includes CR level parameters, and wherein the CR level template form can provide various fields for multiple selections with respect to approval. Here, in operation, the security approval module 204 can check an auto-approval rule set for a CR, and if certain conditions and criteria are met with respect to the auto-approval rules (wherein the auto-approval rule set pertains to security level criteria), then the CR can be automatically approved by the security approval module 204.

Still referring to FIG. 2, after the security approval module 204, the CR can be sent to an operations approval module 206 for approval of the CR at the operations level of the organization. Here, an SXC template form within the system can be used for the approval process, wherein the template generally includes CR level parameters and a single select field for a CR type. However, within the SXC template, if a CR type is selected as being a non-standard CR, an additional check box may be provided for selection if a change approval board (“CAB”) (i.e., manual approval process) has been specified or requested for the CR, which can be auto approved via a CAB approval module 208. Here, in operation, the operations approval module 206 can check an auto-approval rule set for a CR, and if certain conditions and criteria are met with respect to the auto-approval rules (wherein the auto-approval rule set pertains to operations level criteria), then the CR can be automatically approved by the operations approval module 206 and sent to a final CR approval module 210 for execution. As previously discussed, if the CR requires CAB approval, then the CR can also be sent to the CAP approval module 208 for automatic approval by the CAB and subsequently sent to the final CR approval module 210 for execution. In particular, CR approval module 210 can store the CR approval and further automatically notify the relevant parties, users, or groups within the organization (such as at the domain, security, and operations level) with respect to approval of the CR, or execute any task with respect to the CR within the organization.

Still referring to FIG. 2, an alternative path for the auto-approval CR's may also exist in the situation where an emergency, urgent, or high priority CR may need approval. Here, an urgent or emergency CR creation module 212 can be used to create such an urgent or time-sensitive CR within the organization, wherein the CR approval process may be expedited. Here, the created emergency CR can be sent to the operations approval module 206 without prior approval by the domain and security level approval modules 202 and 204, respectively. Next, the approved CR from module 206 can then be sent to an emergency CAB (“ECAB”) approval module 216 for approval by the ECAB.

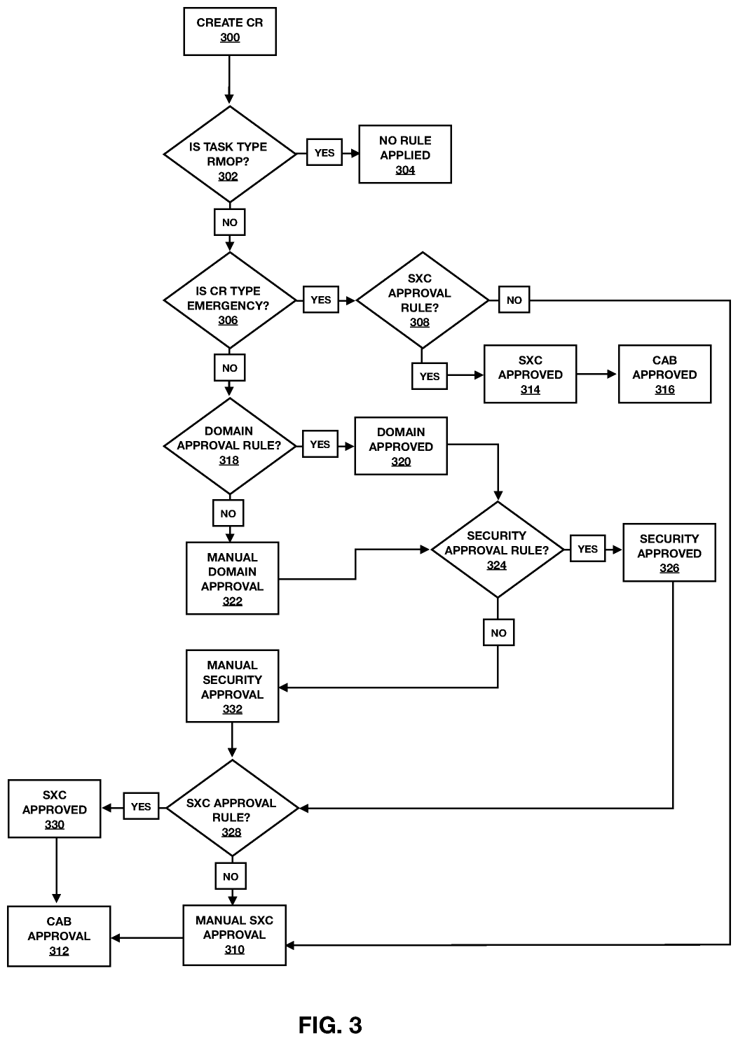

FIG. 3 illustrates one exemplary embodiment of a detailed process flow for the rule-based CR approval system and method of the disclosure described herein. Here, the process can start at step 300 where a new CR is created using a CR template form, such as shown in FIG. 4. Here, various types of pre-defined CR fields can be selected and/or populated within the CR template form. These fields can include, but are not limited to: ticket family name, CR title, CR cause (e.g., network maintenance), CR type (e.g., normal), CR priority (e.g., level 3/low priority), CR activity type (e.g., project), whether the CR has a security impact on the organization, network, or system, the security risk level (e.g., high), if the CR is a test, duration of an outage based on the CR (e.g., 1-hour), execution work group for the CR (e.g., internal change management), network domain (e.g., RAN), vendor type, and NE type (e.g., macro), among others. Next, at step 302, the system can determine if a CR task type is a remote method of procedure (“RMOP”), and if yes, then no rules are applied or checked against the CR (e.g., auto-approval does not apply and manual approval required), and if no, then the process can move to step 306.

Still referring to FIG. 3, at step 306, the system can determine if a CR type is designated as an emergency, urgent, or high priority CR, and if yes, then the process can move to step 308, and if no, then the process can move to step 318. At step 308, the process can apply SXC related approval rules (e.g., auto-approval rule set), conditions, or criteria to the CR and if the CR meets the threshold of those rules, conditions, or criteria, then the process can move to step 314, and if not, then the process can move to step 310. Here, the fields with respect to the SXC related approval rules within a template can include but are not limited to: ticket family name, CR title, CR cause (e.g., network maintenance), CR type (e.g., normal), CR priority (e.g., level 3/low priority), CR activity type (e.g., project), whether the CR has a security impact on the organization, network, or system, the security risk level (e.g., high), if the CR is lab tested, duration of an outage based on the CR (e.g., 1-hour), execution work group for the CR (e.g., internal change management), network domain (e.g., RAN), vendor type, and NE type (e.g., macro), among others. At step 314, the SXC approval module can approve the CR and the process can move to step 316, where the CAB approval module can also automatically approve the CR. At step 310, the CR can be manually approved by the SXC, and upon manual approval, the process can move to step 312, wherein the CR can be automatically approved by the CAB approval module.

Still referring to FIG. 3, at step 318, the system can apply domain level related approval rules (e.g., auto-approval rule set), conditions, or criteria to the CR and if the CR meets the threshold of those rules, conditions, or criteria, then the process can move to step 320, and if not, then the process can move to step 322. Here, the fields with respect to approval rules within a domain template form can include, but are not limited to: ticket family name, CR title, CR cause (e.g., network maintenance), CR type (e.g., normal), CR priority (e.g., level 3/low priority), CR activity type (e.g., project), whether the CR has a security impact on the organization, network, or system, the security risk level (e.g., high), if the CR has lab tested, duration of an outage based on the CR (e.g., 1-hour), execution work group for the CR (e.g., internal change management), network domain (e.g., RAN), vendor type, and NE type (e.g., macro), among others. At step 320, the domain approval module can automatically approve the CR and the process can proceed to step 324.

Still referring to FIG. 3, at step 322, the CR can be approved manually at the domain level and the process can proceed to step 324. At step 324, the system can apply security level related approval rules (e.g., auto-approval rule set), conditions, or criteria to the CR and if the CR meets the threshold of those rules, conditions, or criteria, then the process can move to step 326, and if not, then the process can move to step 332. Here, the fields with respect to approval rules within a security template form can include, but are not limited to: ticket family name, CR title, CR cause (e.g., network maintenance), CR type (e.g., normal), CR priority (e.g., level 3/low priority), CR activity type (e.g., project), whether the CR has a security impact on the organization, network, or system, the security risk level (e.g., high), if the CR has lab tested, and duration of an outage based on the CR (e.g., 1-hour), among others. At step 326, the security approval module can automatically approve the CR and the process can proceed to step 328. At step 332, the CR can be approved manually at the security level and the process can proceed to step 328. At step 328, the system can apply SXC level related approval rules (e.g., auto-approval rule set), conditions, or criteria to the CR and if the CR meets the threshold of those rules, conditions, or criteria, then the process can move to step 330, and if not, then the process can move to step 310. At step 330, the SXC/operations approval module can automatically approve the CR and the process can proceed to step 312, wherein the CAB approval module can also automatically approve the CR.

FIG. 4 illustrates one exemplary embodiment of a template form for creating a CR and defining one or more rules, conditions, or criteria with respect to the created CR. Here, the template form can include fields for defining a CR title, Rules, Ticket Family, Cause of CR, CR Type, Priority, CR Activity Type, Security Impact, Change Risk, CR Tested Lab, Outage Duration, Caretaker Domain, and Vendor. However, it is contemplated within the scope of the present disclosure described herein that the template form can include any other fields with respect to creating rules for a CR.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, microservice(s), segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of automatically approving change requests within an organization, the method comprising:
creating a change request (CR) based on a received request to create the CR; and
defining one or more conditions associated with the CR, wherein the conditions are based on at least one of a domain level, security level, or operations level within the organization.

2. The method of claim 1, further comprising:
determining if the CR meets the one or more conditions with respect to the domain level within the organization; and
upon determining that the CR meets the one or more conditions with respect to the domain level within the organization, automatically approving the CR at the domain level of the organization.

3. The method of claim 2, further comprising:
determining if the CR meets the one or more conditions with respect to the security level within the organization; and
upon determining that the CR meets the one or more conditions with respect to the security level within the organization, automatically approving the CR at the security level of the organization.

4. The method of claim 3, further comprising:
determining if the CR meets the one or more conditions with respect to the operations level within the organization; and
upon determining that the CR meets the one or more conditions with respect to the operations level within the organization, automatically approving the CR at the operations level of the organization.

5. The method of claim 4, further comprising:
sending the approved CR at the domain level, security level, and operations level to an approval board.

6. The method of claim 5, further comprising:
upon approval of the CR from the approval board, automatically executing the CR within the organization.

7. The method of claim 1, further comprising:
determining if the CR is a remote method of procedure.

8. The method of claim 7, further comprising:
upon determining that the CR is not a remote method of procedure, determining if the CR is high priority.

9. The method of claim 8, further comprising:
upon determining that the CR is high priority, determining if the CR meets the one or more conditions with respect to the operations level within the organization; and
upon determining that the CR meets the one or more conditions with respect to the operations level within the organization, automatically approving the CR at the operations level of the organization.

10. The method of claim 9, further comprising:
sending the approved CR at the operations level to an approval board; and
upon approval of the CR from the approval board, automatically executing the CR within the organization.

11. An apparatus for automatically approving change requests within an organization, comprising:
a memory storage storing computer-executable instructions; and
a processor communicatively coupled to the memory storage, wherein the processor is configured to execute the computer-executable instructions and cause the apparatus to:
create a change request (CR) based on a received request to create the CR; and
define one or more conditions associated with the CR, wherein the conditions are based on at least one of a domain level, security level, or operations level within the organization.

12. The apparatus of claim 11, wherein the computer-executable instructions, when executed by the processor, further cause the apparatus to:
determine if the CR meets the one or more conditions with respect to the domain level within the organization; and
upon determining that the CR meets the one or more conditions with respect to the domain level within the organization, automatically approve the CR at the domain level of the organization.

13. The apparatus of claim 12, wherein the computer-executable instructions, when executed by the processor, further cause the apparatus to:
determine if the CR meets the one or more conditions with respect to the security level within the organization; and
upon determining that the CR meets the one or more conditions with respect to the security level within the organization, automatically approve the CR at the security level of the organization.

14. The apparatus of claim 13, wherein the computer-executable instructions, when executed by the processor, further cause the apparatus to:
determine if the CR meets the one or more conditions with respect to the operations level within the organization; and
upon determining that the CR meets the one or more conditions with respect to the operations level within the organization, automatically approve the CR at the operations level of the organization.

15. The apparatus of claim 14, wherein the computer-executable instructions, when executed by the processor, further cause the apparatus to:
send the approved CR at the domain level, security level, and operations level to an approval board.

16. The apparatus of claim 15, wherein the computer-executable instructions, when executed by the processor, further cause the apparatus to:
upon approval of the CR from the approval board, automatically execute the CR within the organization.

17. The apparatus of claim 11, wherein the computer-executable instructions, when executed by the processor, further cause the apparatus to:
determine if the CR is a remote method of procedure.

18. The apparatus of claim 17, wherein the computer-executable instructions, when executed by the processor, further cause the apparatus to:
upon determining that the CR is not a remote method of procedure, determine if the CR is high priority.

19. The apparatus of claim 18, wherein the computer-executable instructions, when executed by the processor, further cause the apparatus to:
upon determining that the CR is high priority, determine if the CR meets the one or more conditions with respect to the operations level within the organization; and
upon determining that the CR meets the one or more conditions with respect to the operations level within the organization, automatically approve the CR at the operations level of the organization.

20. A non-transitory computer-readable medium comprising computer-executable instructions for automatically approving change requests within an organization by an apparatus, wherein the computer-executable instructions, when executed by at least one processor of the apparatus, cause the apparatus to:
create a change request (CR) based on a received request to create the CR; and
define one or more conditions associated with the CR, wherein the conditions are based on at least one of a domain level, security level, or operations level within the organization.
